(19) United States
(12) Patent Application Publication
(10) Pub. No.: US 2023/0028415 A1
(43) Pub. Date: Jan. 26, 2023

(54) METHOD, COMPUTING UNIT AND COMPUTER PROGRAM FOR OPERATING AN SCR CATALYTIC CONVERTER

(71) Applicant: Robert Bosch GmbH, Stuttgart (DE)

(72) Inventors: Thorsten Meier, Pfinztal-Kleinsteinbach (DE); Arman Khosravani, Freiberg Am Neckar (DE); Stefanos Tzivanakis, Waiblingen (DE)

(21) Appl. No.: 17/871,116

(22) Filed: Jul. 22, 2022

(30) Foreign Application Priority Data
Jul. 23, 2021 (DE) 10 2021 207 934.2

(51) Int. Cl. F01N 3/20; F01N 3/08

(52) U.S. Cl. CPC F01N 3/208; F01N 3/0842

(57) ABSTRACT

A method for operating an SCR catalytic converter in an exhaust gas system of an internal combustion engine with ammonia dosing upstream of the catalytic converter. The method includes: determining, on the basis of a catalytic converter model, the efficiency of nitrogen oxide conversion in the catalytic converter; determining an ammonia fill level in the catalytic converter; determining a nominal ammonia fill level in the catalytic converter, based on the determined efficiency and a pre-definable target nitrogen oxide conversion; and controlling the ammonia dosing depending on the nominal ammonia fill level and the ammonia fill level.

### CROSS REFERENCE

The present application claims the benefit under 35 U.S.C. § 119 of German Patent Application No. DE 10 2021 207 934.2 filed on Jul. 23, 2021, which is expressly incorporated herein by reference in its entirety.

### FIELD

The present invention relates to a method for operating an SCR catalytic converter and also to a computing unit and to a computer program for carrying out the method.

### BACKGROUND INFORMATION

Selective catalytic reduction (SCR) using ammonia (NH₃) or ammonia-releasing reagents constitutes a promising method for reducing nitrogen oxides (NOₓ) in oxygen-rich exhaust gases. The operating window of an SCR catalytic converter and its effectiveness or efficiency are, for the most part, determined by the physical variables: temperature and space velocity. A decisive factor for efficiency is the degree of coverage of the catalyst with adsorbed NH₃. To achieve the highest possible nitrogen oxide conversion rates, it is often expedient to operate the SCR system with a high ammonia fill level.

### SUMMARY

According to the present invention, a method for operating an SCR catalytic converter, a computing unit, and a computer program for carrying out the method, are provided. Advantageous configurations of the present invention are disclosed herein.

Firstly, for better understanding, some of the terms and concepts used here shall be briefly explained below.

Reference to “ammonia” shall generally be understood to mean ammonia and/or an ammonia-generating compound, such as, e.g., ammonium hydroxide or urea (solution).

An SCR catalytic converter (Selective Catalytic Reaction) within the context of this invention is a catalytic converter which is designed for catalytic conversion of nitrogen oxides with ammonia to nitrogen and water (vapor). A typical SCR catalytic converter combines ammonia adsorbed on a catalytically active surface of the catalyst with nitrogen oxide in the gas phase, the nitrogen of the ammonia being oxidized, while the nitrogen of the nitrogen oxide is reduced. This is therefore a symproportionation reaction, in which nitrogen is produced as a product. In the process, the hydrogen atoms of the ammonia and the oxygen atoms of the nitrogen oxide combine to form water.

Within the context of the present explanations, the effectiveness or efficiency of a reaction is to be understood as the relationship between a stoichiometric reaction conversion and a reaction conversion that can be kinetically achieved or is actually achieved under the given conditions. For example, the efficiency may be described by the formula 1—(NOₓDS/NOₓUS), NOₓDS denoting the amount of nitrogen oxide downstream of the catalytic converter and NOₓUS denoting the amount of nitrogen oxide upstream of the catalytic converter. Complete conversion of the nitrogen oxides would therefore yield an efficiency of 1, while zero conversion would result in an efficiency of 0.

In contrast to conventional methods, in the method according to the present invention, the amount of ammonia which is actually required for the desired nitrogen oxide conversion at a given operating point is determined and fed accordingly into the exhaust gas system upstream of the SCR catalytic converter. To this end, the efficiency of the conversion is determined while, customarily, only a predetermined ammonia fill level of the catalytic converter is adjusted, considering the average temperature of the catalytic converter and not taking into account the temperature-dependent dynamics of the system. The method according to the present invention may thus ensure reliable exhaust gas denitrification in a relatively wide range of dynamic operating states and therefore contribute to an overall reduction in harmful emissions.

In detail, a method according to an example embodiment of the present invention for operating an SCR catalytic converter with ammonia dosing upstream of the catalytic converter comprises: determining an efficiency of nitrogen oxide conversion in the catalytic converter on the basis of a catalytic converter model; determining an ammonia fill level in the catalytic converter;

determining a nominal ammonia fill level in the catalytic converter, based on the determined efficiency and a pre-definable target nitrogen oxide conversion; and controlling the ammonia dosing depending on the nominal ammonia fill level and the ammonia fill level. In this case, on the basis of the catalytic converter model, the amount of ammonia which is currently required for the conversion is determined and the ammonia dosing is optimally adjusted, taking into account the ammonia already in the system.

As mentioned, the operating point of an SCR catalytic converter is essentially determined by the amount of adsorbed ammonia (NH₃ fill level). The ability of an SCR catalyst to store ammonia is decisively influenced by the temperature of the catalytic converter. The ability to store ammonia decreases as the temperature increases. To maintain high effectiveness, the amount of ammonia required to convert a measured amount of nitrogen oxide should be dosed appropriately over time upstream of the SCR catalytic converter. Ammonia which does not react with NOₓ, desorbed from the catalyst as ammonia slip or oxidized on the catalyst due to the high temperature, should likewise be re-dosed. If the temperature of the filled SCR catalyst increases, for example due to a sudden load change of the internal combustion engine which generates the exhaust gas, its ammonia storage capacity is reduced, which may result in corresponding ammonia slip. SCR catalytic converters, which are installed near to the engine in order to convert nitrogen oxides soon after the engine is started, are particularly exposed to dynamic temperature gradients. Depending on the NH₃ fill level or the gradients thereof, this may result in increased NH₃ desorption.

By using suitable SCR models (e.g., reaction kinetic models/Arrhenius models), for a certain fill level of the catalytic converter (mNH₃Cat: ammonia mass in the catalytic converter) and ammonia dosing (NH₃Dosing: added ammonia mass), the concentrations of NOₓ (cNOₓDs) and NH₃ (cNH₃Ds) are calculated or estimated downstream of the catalytic converter, it being possible to additionally take into account aging parameters (CatAgeing), catalytic converter temperature (TempCat) and exhaust gas mass flow rate (ExhMass). It is thus possible to obtain functions in the form:

cNOₓDs (mNH₃Cat, CatAgeing, NH₃Dosing, TempCat, ExhMass)

cNOₓDs (mNH₃Cat, CatAgeing, NH₃Dosing, TempCat, ExhMass)

Consequently, the efficiency with regard to the nitrogen oxide conversion (NOₓ conversion) may be determined depending on the said variables, as described at the outset, in particular according to 1—(NOₓDs/NOₓUs).

With the present invention, an NH₃ fill level (mNH₃Cat_{Eta}) of the catalytic converter which is actually required according to the determined efficiency may be assigned to a desired NOₓ conversion or a desired maximum concentration of NOₓ downstream of the catalytic converter (cNOₓDs), and a target fill level (mNH₃Catₙₒₘ) of the catalytic converter may therefore be specified for this conversion or this efficiency of the conversion (EtaNOₓ).

mNH₃Catₙₒₘ=mNH₃Cat_{Eta}(cNOₓDs)

In most cases, it is not possible to calculate this fill level using analytical methods. To determine the efficiency-based fill level, it is possible to apply, e.g., numerical mathematical methods from the area of zero determination in order to calculate or approximate the NH₃ fill level. A simple bisection method, secant method, Newton method or the Broyden method shall be mentioned as examples here. In these methods, the independent variable (the dosing amount in this case) is iteratively varied, so as to find the dependent variable (the fill level in this case) with which the desired efficiency is realized.

The method may be applied to systems in which the SCR catalytic converter is assumed to be an ideally mixed complete system (single disk model) or as a cascade of a plurality of ideally mixed subsystems (multi-disk model). In the latter case, an individual temperature may be associated with each disk. In this case, a stationary fill level distribution may determined. The total fill level is associated with the discretization (disks) as follows:

mNH₃Cat_{Eta}=Σⁿᵢ₌₁mNH₃Catᵢ

mNH₃Catᵢ indicating the fill level of the i-th disk.

In accordance with an example embodiment of the present invention, the method may be optionally combined with the auxiliary condition for limiting the expected ammonia slip in the case of high conversion rates.

mNH₃Catₙₒₘ=mNH₃Cat_{Eta}(cNOₓDs, cNH₃Ds)

This method may ensure a high conversion in the event of a sudden engine load change (change in the operating point), which leads to an increase in the temperature in the SCR catalytic converter or to a dynamic temperature gradient. In contrast to fill-level-based regulation, which only compares the actual fill level with the target fill level, the method proposed here, if applicable, provides different target values, which are calculated based on the effectiveness. The scenario of a positive temperature gradient is given as a possible example. The fill-level-based regulation would result in a planned reduction in the fill level in order to prevent ammonia slip through increased desorption, which might in turn provoke a dosing break. In contrast to this, the efficiency-based method proposed here might result in a higher planned total fill level, which does not lead to a dosing break. In this case, for example, it is possible to assess whether the resultant higher conversion of nitrogen oxides justifies the associated increased ammonia slip. By taking into account the reaction kinetics, the fill level control may be configured to be less restrictive with regard to ammonia emissions. Since current engine operating points are included in the recursive calculation of the efficiency-based target fill level, in advantageous configurations, provision may be made to ensure, via a minimum selection feature, that the fill level does not fall below a minimum fill level. This may prevent too low an ammonia fill level being established in the catalytic converter as a result of unfavorable combinations of certain boundary conditions (e.g., temperature, exhaust gas mass flow, . . . ).

A computing unit according to the present invention, e.g. a control unit of a motor vehicle, is designed, in particular in terms of programming, to carry out a method according to the present invention.

The implementation of a method according to the present invention in the form of a computer program or computer program product with program code for carrying out all method steps is advantageous, since this incurs particularly low costs, in particular if a control unit executing the method is also used for further tasks and is therefore present in any case. Suitable data carriers for providing the computer program are, in particular, magnetic, optical and electrical memories, such as, e.g., hard drives, flash memories, EEPROMs, DVDs, etc. It is also possible to download a program via computer networks (Internet, Intranet, etc.).

Further advantages and configurations of the present invention are disclosed in the description and in the figures.

The present invention is schematically illustrated in the figures on the basis of an exemplary embodiment/exemplary embodiments and will be described below with reference to the figures.

### BRIEF DESCRIPTION OF THE DRAWINGS

FIG. 1 shows an example of a motor vehicle, which may be used within the context of the present invention, in a schematic illustration.

FIG. 2 schematically shows an advantageous configuration of a method according to the present invention in the form of a highly simplified flow chart.

### DETAILED DESCRIPTION OF EXAMPLE EMBODIMENTS

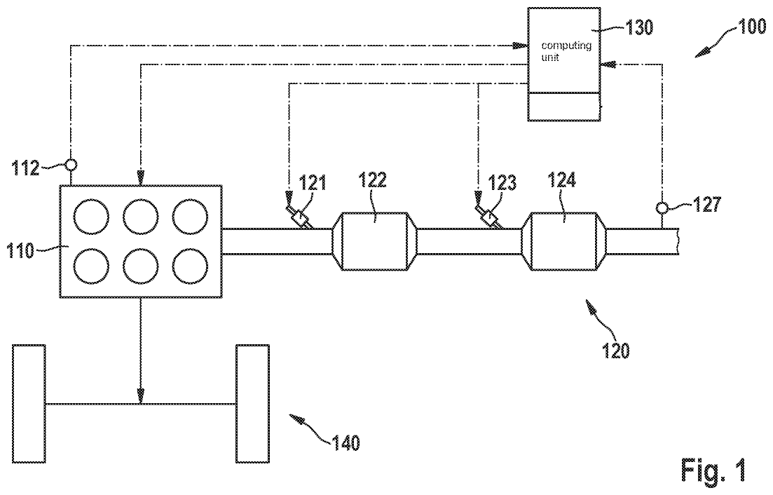

In FIG. 1, an example of a motor vehicle, as may be used within the context of the present invention, is schematically illustrated and is denoted as a whole by 100. The vehicle 100 comprises an internal combustion engine 110, for example with six cylinders shown here, an exhaust gas system 120, which has a plurality of purification components 122, 124, e.g. catalytic converters and/or particulate filters, wheels 140 driven by the internal combustion engine 110, and also a computing unit 130, which is designed to control the internal combustion engine 110 and exhaust gas system and is connected in a data-conducting manner thereto. Furthermore, the computing unit 130 in the illustrated example is connected in a data-conducting manner to sensors 112, 127, which record operating parameters of the internal combustion engine 110 and/or the exhaust gas system 120. It goes without saying that further sensors may be present, which are not illustrated.

Within the context of the further description, it is assumed that the purification components 122, 124 are a combined oxidation catalytic converter with particulate filter 122 and an SCR catalytic converter 124. An inlet of a secondary air system 121 may be provided upstream of the oxidation catalytic converter/particulate filter 122, it being possible to add air to the exhaust gas system 120 via the said inlet, for example for regeneration of the particulate filter 122. This inlet of the secondary air system may also be omitted, in particular in the case of lean engines, since, in such a case, sufficient oxygen for combustion of soot particles is generally contained in the exhaust gas generated by the internal combustion engine 110.

A reduction-agent dosing device 123 is provided upstream of the SCR catalytic converter. This dosing device may be designed for example for urea-solution dosing, ammonia being produced from the urea solution at high temperatures. The dosing device 123 is therefore also referred to simply as ammonia dosing 123.

A second catalytic converter (not shown) may be provided downstream of the first catalytic converter 124 in the exhaust gas system 120 in order to adsorb and convert ammonia from the ammonia slip of the catalytic converter 124. For cost reasons, single ammonia dosing 123 may be provided upstream of the first SCR catalytic converter 124 in order to feed the urea solution into the exhaust gas system. In such a configuration, the second SCR catalytic converter is filled only with ammonia slip from the first SCR catalytic converter 124.

The guidelines for on-board diagnostics (OBD) stipulate that SCR catalytic converters which are present must be monitored. To this end, a nitrogen oxide sensor is generally present downstream of each SCR catalytic converter. The sensor data may be used to model the fill level of the SCR catalytic converters.

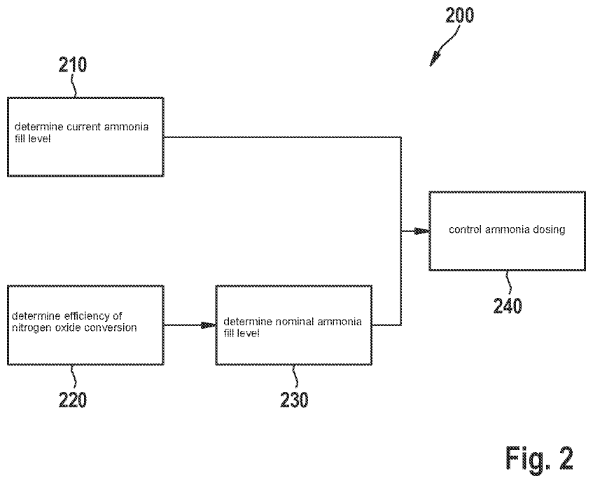

However, the physical fill levels may differ significantly from the modeled fill levels, e.g. in the event of deviations from the modeled aging of the SCR catalytic converters. This may lead to changes in the effectiveness of the nitrogen oxide reduction and therefore possibly to the emission limits being exceeded. This may be improved by an advantageous configuration of a method according to the present invention, as shown in FIG. 2.

In FIG. 2, an advantageous configuration of a method according to the present invention is schematically illustrated in the form of a highly simplified flow chart and is denoted as a whole by 200. The method serves for operating an SCR catalytic converter and is also described below with reference to FIG. 1.

In a first step 210 of the method 200, a current ammonia fill level of the SCR catalytic converter 124 is determined. To this end, for example, dosing amounts of the ammonia dosing 123 and/or data of one or more nitrogen oxide sensors 127 may be used upstream (not shown) and/or downstream of the catalytic converter 124 and, for example, offset against each other.

In a second step 220 of the method, which may also be carried out in parallel with the first step 210, the efficiency of the nitrogen oxide conversion in the catalytic converter 124 is determined. To this end, a physical model of the catalytic converter 124 is used, in which input variables, such as, for example, catalytic converter temperature, exhaust gas mass flow rate, exhaust gas composition (e.g., lambda value, NOₓ sensor signal, . . . ) and, if applicable, further parameters are included. The model may be provided, e.g., as a single-disk model (assuming a homogeneous mix in the catalytic converter 124) or as a multi-disk model (assuming a plurality of zones, each with different ammonia or nitrogen oxide fill levels and/or temperatures within the catalytic converter 124). Such a catalytic converter model may, if applicable, also be used for determining the ammonia fill level in step 210. Suitable catalytic converter models are described, for example, in the from the following articles:

Sjövall, H.; Blint, R. J.; Olsson, L.: Detailed kinetic modeling of NH3 SCR over Cu-ZSM-6. Applied Catalysis B: Environmental 92 (2009) p. 138-153

Tronconi, E.; Cavanna, A.; Forzatti, P.: Unsteady Analysis of NO Reduction over Selective Catalytic Reduction-De-NOx Monolith Catalysts. Industrial and engineering chemistry research; Vol 37 Nr. 6 (1998) p. 2341-2349

Olsson, L.; Sjövall, H.; Blint, R.: A kinetic model for ammonia selective catalytic reduction over Cu-ZSM-5. Applied Catalysis B: Environmental 81 (2008) p. 203-217.

On the basis of the determined conversion efficiency, a nominal ammonia fill level for the catalytic converter 124 is determined in a subsequent step 230. To this end, the determined efficiency may be compared to a target efficiency or a target conversion, which may be predetermined empirically and/or specified on the basis of legal requirements.

In a control step 240, depending on the determined nominal fill level and the determined fill level, the ammonia dosing 123 may then be controlled such that the nominal fill level is also actually established in the catalytic converter 124 or the actual fill level approaches the nominal fill level. If, for example, the nominal fill level is higher that the determined current fill level, in step 240, an amount of reducing agent, added to the exhaust gas system 123 via the ammonia dosing 123, may be increased, or vice versa, in step 240.

The method may return to steps 210 and 220 again after the control step 240.

It should be emphasized that the described step-by-step procedure serves merely for explanation and should not be construed as restrictive. In fact, the method 200 may also be carried out substantially continuously and some or all of the steps 210 to 240 may be carried out in parallel with each other so long as this is useful and/or possible.

What is claimed is:

1. A method for operating an SCR catalytic converter in an exhaust gas system of an internal combustion engine with ammonia dosing upstream of the catalytic converter, the method comprising the following steps:
determining, based on a catalytic converter model, an efficiency of nitrogen oxide conversion in the catalytic converter;
determining an ammonia fill level in the catalytic converter;
determining a nominal ammonia fill level in the catalytic converter, based on the determined efficiency and a pre-definable target nitrogen oxide conversion; and
controlling the ammonia dosing depending on the nominal ammonia fill level and the ammonia fill level.

2. The method as recited in claim 1, wherein the catalytic converter model takes into account at least one temperature of the catalytic converter, an exhaust gas mass flow rate, a catalytic converter aging parameter, and an amount of ammonia added via the ammonia dosing.

3. The method as recited in claim 1, further comprising:
determining the ammonia fill level and/or the nominal ammonia fill level for each of a plurality of zones of the catalytic converter.

4. A computing unit configured to operate an SCR catalytic converter in an exhaust gas system of an internal combustion engine with ammonia dosing upstream of the catalytic converter, the computing unit configured to:
determine, based on a catalytic converter model, an efficiency of nitrogen oxide conversion in the catalytic converter;
determine an ammonia fill level in the catalytic converter;
determine a nominal ammonia fill level in the catalytic converter, based on the determined efficiency and a pre-definable target nitrogen oxide conversion; and
control the ammonia dosing depending on the nominal ammonia fill level and the ammonia fill level.

5. A non-transitory machine-readable storage medium on which is stored a computer program for operating an SCR catalytic converter in an exhaust gas system of an internal combustion engine with ammonia dosing upstream of the catalytic converter, the computer program, when executed by a computer, causing the computer to perform the following steps:
determining, based on a catalytic converter model, an efficiency of nitrogen oxide conversion in the catalytic converter;
determining an ammonia fill level in the catalytic converter;
determining a nominal ammonia fill level in the catalytic converter, based on the determined efficiency and a pre-definable target nitrogen oxide conversion; and
controlling the ammonia dosing depending on the nominal ammonia fill level and the ammonia fill level.
